(19) United States
(12) Patent Application Publication
(10) Pub. No.: US 2017/0198783 A1
(43) Pub. Date: Jul. 13, 2017

(54) LOW PROFILE TORSIONAL DAMPER FOR SHAFTS

(71) Applicant: Ford Global Technologies, LLC, Dearborn, MI (US)

(72) Inventors: Djamel BOUZIT, Ann Arbor, MI (US); Javed IQBAL, Farmington Hills, MI (US)

(21) Appl. No.: 14/994,665

(22) Filed: Jan. 13, 2016

(51) Int. Cl. F16F 15/124; F16F 15/12

(52) U.S. Cl. CPC F16F 15/1245; F16F 15/1208

(57) ABSTRACT

A torsional damper according to the present disclosure includes an inner sleeve and an outer sleeve. The inner sleeve is configured to couple with a shaft, arranged concentrically with an axis of rotation. The inner sleeve has a generally annular profile with a periphery and a male spline extending from the periphery. The outer sleeve is disposed about the inner sleeve, and arranged concentrically with the inner sleeve. The outer sleeve has a generally annular profile with a periphery and a female spline recessed within the periphery. The inner and outer sleeves are arranged with the male spline disposed within the female spline. The damper additionally includes a resilient coupler arranged between the male spline and the female spline. The damper further includes a ball disposed between the inner sleeve and the outer sleeve and configured to inhibit radial motion of the outer sleeve relative to the inner sleeve.

### TECHNICAL FIELD

The present disclosure relates to a torsional damper device for shafts, particularly driveshafts in automotive vehicles.

### BACKGROUND

An automotive drivetrain will generally include a driveshaft or propeller shaft arranged between a propulsive source, such as an internal combustion engine or electric motor, and vehicle traction wheels. Such shafts may experience torsional vibrations based on a natural frequency of the shaft. Torsional vibrations refer to angular vibrations, e.g. about the axis of rotation of the shaft. These vibrations may in some cases arise from the periodic nature of combustion in the engine cylinders, and may be transmitted through the drivetrain, e.g. via the driveshaft, to a vehicle suspension, and thereafter through the vehicle body to an occupant. Torsional vibrations may cause undesirable noise, and in the extreme may fatigue and degrade components of the drivetrain, decreasing life of the components. Torsional vibrations may be reduced in various ways, including tuning of the drivetrain components or including an active or passive damper.

### SUMMARY

A torsional damper according to the present disclosure includes an inner sleeve and an outer sleeve. The inner sleeve is configured to couple with a shaft, arranged concentrically with an axis of rotation. The inner sleeve has a generally annular profile with a periphery and a male spline extending from the periphery. The outer sleeve is disposed about the inner sleeve, and arranged concentrically with the inner sleeve. The outer sleeve has a generally annular profile with a periphery and a female spline recessed within the periphery. The inner and outer sleeves are arranged with the male spline disposed within the female spline. The damper additionally includes a resilient coupler arranged between the male spline and the female spline. The damper further includes a ball disposed between the inner sleeve and the outer sleeve and configured to inhibit radial motion of the outer sleeve relative to the inner sleeve.

According to a first embodiment, the resilient coupler comprises elastomeric material.

According to a second embodiment, the inner sleeve further includes a flange extending from the periphery. The flange has an outer surface with a groove thereon, and the ball is retained in the groove.

According to a third embodiment, the outer sleeve comprises metal, which may include iron or steel.

According to a fourth embodiment, a drive shaft is provided. The drive shaft extends from a first end to a second end with a central portion therebetween. The inner sleeve is concentrically coupled with the shaft.

A damper for a shaft according to the present disclosure includes a first sleeve and a second sleeve. The first sleeve has a generally ring-shaped cross-section with a male spline extending from a perimeter. The second sleeve has a generally ring-shaped cross-section with a female spline recessed within a perimeter. The first and second sleeves are arranged concentrically with the male spline disposed within the female spline. The damper additionally includes an elastomeric material arranged between the male and female splines and a filler material disposed between the first and second sleeves.

According to a first embodiment, the second sleeve is arranged about the first sleeve.

According to a second embodiment, the female spline has a first sidewall and the male spline has a second sidewall. The elastomeric material is arranged between the first sidewall and the second sidewall.

According to a third embodiment, the filler material comprises polystyrene.

A torsional damper according to the present disclosure includes a first annular sleeve and a second annular sleeve. The first sleeve has an outer periphery with a lug extending therefrom. The second sleeve has an inner periphery with a cavity recessed therein. The second annular sleeve is arranged concentrically about the first annular sleeve with the lug disposed in the cavity. The torsional damper additionally includes a resilient coupler disposed between the lug and the cavity. The torsional damper further includes a bearing disposed between the first and second sleeves to inhibit relative motion therebetween.

According to a first embodiment, the first sleeve includes a second lug, a third lug, and a fourth lug extending from the outer periphery. The lugs are spaced generally equally about the outer periphery. In a variation of this embodiment, the second sleeve includes a second cavity, a third cavity, and a fourth cavity recessed in the inner periphery. The cavities are spaced generally equally about the inner periphery, with the second lug disposed in the second cavity, the third lug disposed in the third cavity, and the fourth lug disposed in the fourth cavity.

According to a second embodiment, wherein the resilient coupler comprises elastomeric material. In a variation of this embodiment, the lug includes a lug sidewall and the cavity includes a cavity sidewall, with the elastomeric material disposed between the lug sidewall and cavity sidewall.

According to a third embodiment, the first sleeve further includes a flange extending from the inner sleeve periphery. The flange has an outer surface with a groove thereon, and the bearing is retained in the groove.

According to a fourth embodiment, the second sleeve comprises metal, which may include iron or steel.

According to a fifth embodiment, a drive shaft is provided. The drive shaft extends from a first end to a second end with a central portion therebetween. The first sleeve is concentrically coupled with the shaft.

According to a sixth embodiment, the bearing includes a ball or pin.

Embodiments according to the present disclosure provide a number of advantages. For example, embodiments according to the present disclosure provide torsional damper devices that may damp torsional vibrations in drive shafts while maintaining a compact size. Furthermore, embodiments according to the present disclosure may be built relatively inexpensively using simple manufacturing techniques.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of an automotive vehicle drivetrain according to the present disclosure;

FIGS. 2A-2C are section views of an inner sleeve of a torsional damper according to the present disclosure;

FIG. 3 is a section view of an outer sleeve of a torsional damper according to the present disclosure;

FIG. 4 is a section view of a first embodiment of a torsional damper according to the present disclosure; and

FIG. 5 is a section view of a second embodiment of a torsional damper according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

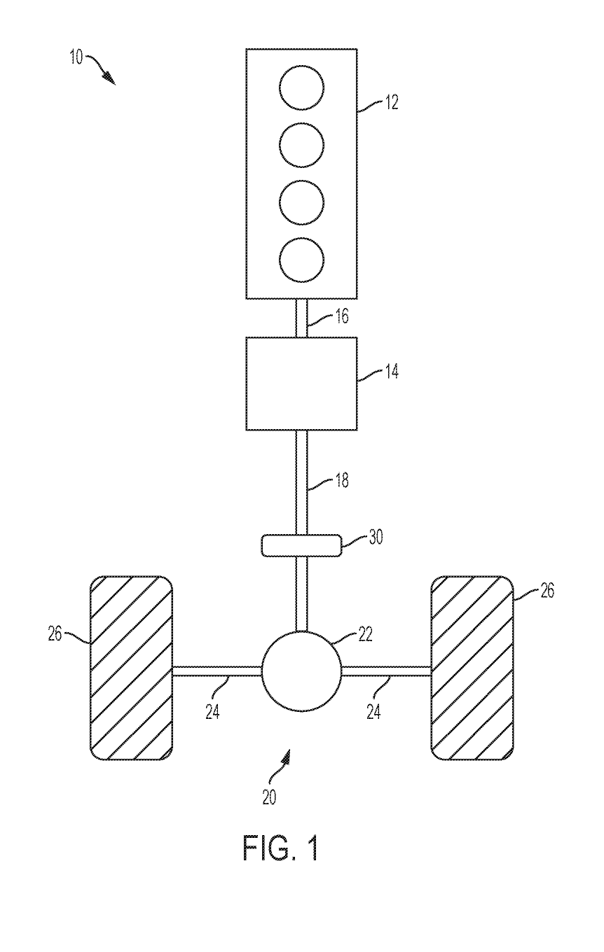

Referring now to FIG. 1, a simplified vehicle drivetrain 10 is shown in schematic form. The drivetrain 10 includes a powerplant or propulsive source 12. In this embodiment, the propulsive source 12 includes an internal combustion engine, which may be gasoline-powered or diesel-powered. However, other embodiments contemplated within the scope of the invention may include other propulsive sources, such as an electric machine in addition to, or in place of, an internal combustion engine.

The drivetrain 10 additionally includes a transmission 14. In various embodiments, the transmission 14 may be an automatic transmission, manual transmission, continuously variable transmission (CVT), power transfer unit, transfer chase, or any other appropriate power transmission mechanism. The transmission 14 is driven by the propulsive source 12 via a shaft 16, which may be a crankshaft. The transmission 14 is, in turn, drivingly coupled with a drive shaft 18. The transmission 14 is configured to establish a plurality of speed and torque ratios between the shaft 16 and the drive shaft 18. In an exemplary embodiment, the transmission 14 is an automatic transmission that includes multiple gearing elements and is configured to automatically engage or disengage shiftable elements, such as clutches, to shift between various gear ratios according to a shift schedule.

The drive shaft 18 is drivingly coupled with an axle 20 via differential 22. The axle 20 includes two half-shafts or side-shafts 24, each coupled with a respective traction wheel 26. Here, traction wheel refers to a driven or non-driven wheel in contact with a driving surface. According to various embodiments, the axle 20 may be a rear axle in a rear-wheel drive platform, or a front axle in a front-wheel drive platform. Embodiments including all-wheel-drive or four-wheel-drive platforms are also considered within the scope of the invention.

While all vehicles may experience torsional vibrations, diesel-powered vehicles may be more susceptible to torsional vibrations due to the increased cylinder pressure present in a diesel engine relative to gasoline-powered engines. As a result, it may be desirable to provide a torsional damper on the drive shaft to inhibit such vibrations.

Torsional dampers may include an inner portion joined to an outer portion via springs or a layer of elastomer. However, the tuning frequency of the damper is based on the moment of inertia of the outer portion, and as such known torsional dampers are relatively large to accommodate an outer portion with a high mass. In smaller vehicles, it may be challenging to package a torsional damper within the available space.

In the following discussion of the Figures, a polar coordinate system is utilized. A radial direction extends from the center of the damper toward an outer periphery. A circumferential direction extends tangentially to the radial direction within the general plane of the damper. An axial direction extends orthogonal to the radial direction, along the central axis of the damper. Furthermore, the relative term outer, e.g. in outer surface, is used to refer to a radially outward portion of a component, e.g. furthest from the central axis. Similarly, the relative term inner, e.g. in inner surface, is used to refer to a radially inward portion of a component, e.g. closest to the central axis.

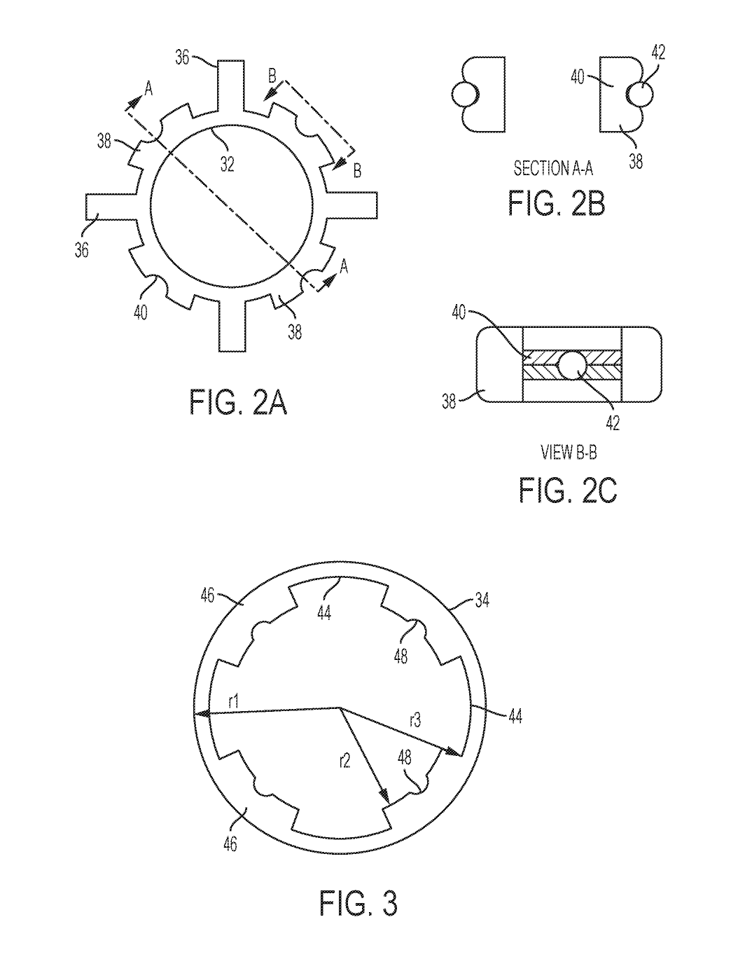

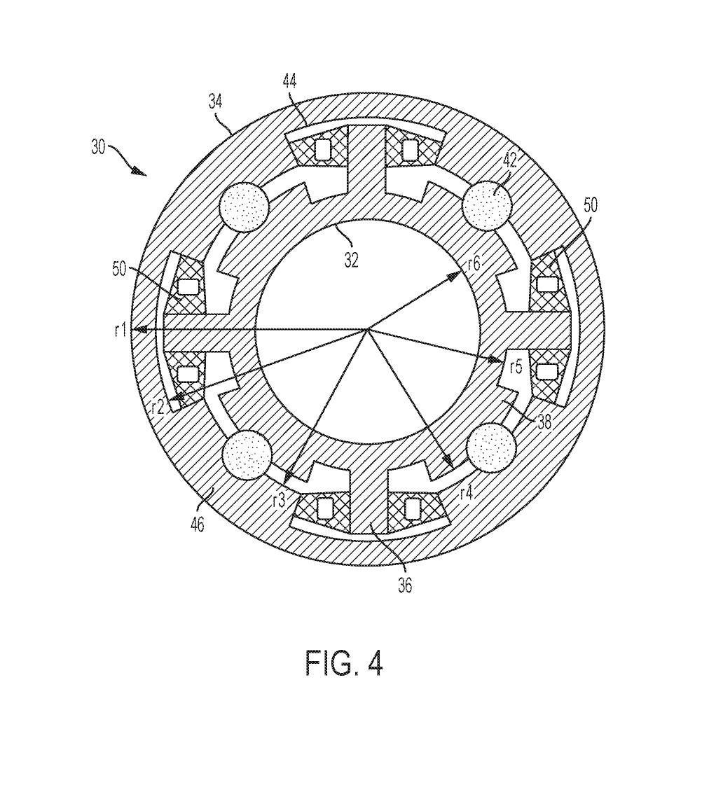

Referring now to FIGS. 1, 2A-C, and 3-4, a torsional damper 30 according to the present disclosure is provided on the drive shaft 18. The torsional damper 30 is preferably press fit to the drive shaft 18, but may be coupled with the drive shaft 18 using any appropriate coupling method. The torsional damper 30 is illustrated in cross section in FIG. 4. The torsional damper 30 includes an inner sleeve 32 and an outer sleeve 34. The inner sleeve 32 is shown in further detail in FIGS. 2A-2C, and the outer sleeve 34 is shown in further detail in FIG. 3. Both the inner sleeve 32 and the outer sleeve 34 are generally annular, or ring-shaped. The inner sleeve 32 has a central orifice sized to accommodate the drive shaft. The outer sleeve 34 has a central orifice sized to accommodate the inner sleeve, such that when assembled, the inner periphery of the outer sleeve 34 is proximate the outer periphery of the inner sleeve 32.

As shown in FIG. 2A, the inner sleeve 32 includes male splines or lugs 36 protruding from the outer periphery. In this representative embodiment, four male splines 36 are shown spaced generally equally about the circumference of the inner sleeve 32, i.e. at approximately 90 degree intervals. However, in other embodiments a greater or fewer number of male splines 36 may be provided, and/or the male splines 36 may be unevenly distributed about the periphery. As an example, an additional embodiment may include three male splines, spaced at approximately 120 degree intervals about the circumference.

The inner sleeve 32 also includes flanges 38 are arranged protruding from the outer periphery. The flanges 38 protrude from the outer periphery between the male splines 36. In this representative embodiment, four flanges 38 are shown spaced generally equally about the circumference of the inner sleeve 32. However, in various other embodiments a greater or fewer number of flanges 38 may be provided, and/or the flanges 38 may be unevenly distributed about the periphery.

As shown in the detail views of FIGS. 2B-C, the flanges 38 are provided with grooves 40 on their outer surfaces. The grooves 40 extend circumferentially along a portion of the outer surfaces of the flanges 38. Each groove 40 has a width that is less than a width of the associated flange 38, and a length that is less than a length of the associated flange 38. As will be discussed in greater detail below with respect to FIG. 4, at least one ball 42 is retained in grooves of the flanges 38.

As shown in FIG. 3, the outer sleeve 34 includes female splines or cavities 44 recessed within the inner periphery. The number and circumferential location of the female splines 44 preferably corresponds to the number and circumferential location of the male splines 36 of the inner sleeve 32. In this embodiment, four female splines 44 are shown spaced generally equally about the circumference of the outer sleeve 34. However, in other embodiments a greater or fewer number of female splines 44 may be provided, and/or the female splines 44 may be unevenly distributed about the inner periphery.

The outer sleeve 34 includes masses 46 in the portions between the female splines 44. The number and circumferential location of the masses 46 preferably corresponds to the number and circumferential location of the flanges 38 of the inner sleeve 32. In this embodiment, four masses 46 are shown spaced generally equally about the circumference of the outer sleeve 34. However, in other embodiments a greater or fewer number of masses 46 may be provided, and/or the masses 46 may be unevenly distributed about the inner periphery. In addition, each mass 46 is provided with a notch 48 on an inner surface.

In a preferred embodiment, the inner sleeve 32 and outer sleeve 34 comprise metallic material, such as steel or iron. Advantageously, embodiments according to the present disclosure may largely be formed by casting, requiring only minimal machining. In an exemplary embodiment, the outer sleeve 34 is cast iron, and the inner sleeve 32 is cast iron, with the grooves 40 added subsequently using known machining techniques. In other embodiments, the grooves 40 may be formed at the time of casting.

Referring now to FIG. 4, when the torsional damper 30 is assembled, the inner sleeve 32 is retained within the outer sleeve 34. The inner sleeve 32 is arranged concentrically with the outer sleeve 34. The male splines 36 are disposed within the female splines 44. The flanges 38 are proximate the masses 46.

A bearing mechanism 42 is retained between the notches 48 of the outer sleeve 34 and the grooves 40 of the inner sleeve 32. In the embodiment illustrated in FIG. 4, the bearing mechanism 42 includes rolling balls. Other embodiments may include rolling pins or other appropriate bearing mechanism. In the embodiment illustrated in FIG. 4, the balls 42 are formed of a relatively stiff material, such as metal or a hard plastic, in order to inhibit radial motion of the outer sleeve 34 relative to the inner sleeve 32. The bearing mechanism 42 maintains the concentricity of the outer sleeve 34 and inner sleeve 32. The bearing mechanism 42 may roll or slide within the grooves 40, and thus enable circumferential motion of the outer sleeve 34 relative to the inner sleeve 32.

Resilient compressible couplings 50 are provided between respective sidewalls of the male splines 36 and adjacent sidewalls of the female splines 44. The couplings 50 preferably comprise elastomeric material such as, for example, a natural rubber. Other known resilient compressible couplings such as springs may, of course, be used. The couplings 50 are tuned for a desired tuning frequency by, for example, selecting an appropriate elastomeric material. The couplings 50 yieldingly resist circumferential motion of the outer sleeve 34 relative to the inner sleeve 32.

The damping coefficient of the torsional damper 30 is a function of the moment of inertia of the outer sleeve 34. To achieve the desired tuning frequency while maintaining a compact size, the configuration of torsional damper 30 has a relatively high mass of the outer sleeve 34 without unduly increasing the outer diameter of the outer sleeve 34. The female splines 44 are relatively narrow, e.g. only slightly wider than the male splines 36. As a result, the masses 46 between the female splines 44 are increased in size. In an exemplary embodiment, the respective masses 46 each have a width of approximately 50 mm, while each respective male spline has a width of approximately 15 mm. Such a configuration provides increased inertia mass in the outer sleeve 34 while minimizing spinning weight of the inner sleeve 32.

Furthermore, the flanges 38 of the inner sleeve 32 are configured to be relatively low profile. As an example, the flanges 38 may project from the outer periphery of the inner sleeve 32 only enough to support the grooves 40 within which the bearing mechanism 42 is retained. As a result, the depth of the masses 46 may be increased to project further from the inner periphery of the outer sleeve 34, thus increasing the mass of the outer sleeve 34.

In an exemplary embodiment, a radius at the inner periphery of the inner sleeve 34 is 35 mm, a radius at the outer periphery of the inner sleeve 34 is 36 mm, and a radius at the outer periphery of the flanges 38 is 37.5 mm. In such an embodiment, a radius at the inner periphery of the masses 46 of the outer sleeve 34 is 40 mm, the radius at the inner periphery of the female splines 44 is 50 mm, and the radius at the outer periphery of the outer sleeve 34 is 60 mm or less. By way of comparison, known torsional dampers have an outer radius of more than 70 mm. As will be understood by one of skill in the art, these values are merely exemplary, and may be tuned according to desired size and performance characteristics for a given application. The torsional damper 30 thus provides desired damping characteristics in a relatively compact package.

It should be noted that specific parameters provided above are merely exemplary. The respective sizes of various components may be selected according to desired characteristics for a specific application.

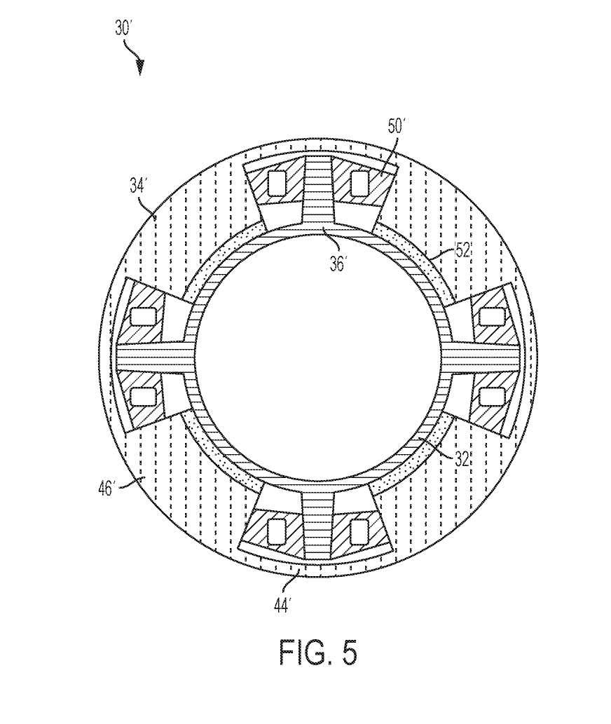

Referring now to FIG. 5, an alternative embodiment of a torsional damper 30′ is shown. The torsional damper 30′ includes an inner sleeve 32′ and an outer sleeve 34′. The inner sleeve 32′ includes male splines 36′ extending from an outer periphery, and the outer sleeve 34′ includes female splines 44′ recessed within an inner periphery. Masses 46′ extend in the portions between the female splines 44′ of the outer sleeve 34′. When assembled, the male splines 36′ are disposed within the female splines 44′.

Resilient compressible couplings 50′ are provided between respective sidewalls of the male splines 36′ and adjacent sidewalls of the female splines 44′. The couplings 50′ preferably comprise elastomeric material such as, for example, a natural rubber. Other known resilient compressible couplings such as springs may, of course, be used. The couplings 50′ yieldingly resist circumferential motion of the outer sleeve 34′ relative to the inner sleeve 32′.

A filler material 52 is provided in the regions between the inner surfaces of the masses 46′ and the outer surfaces of the inner sleeve 32′. Additional portions of filler material (not illustrated) may also be provided in regions between the outer surfaces of the male splines 36′ and the inner surfaces of the female splines 44′. The filler material may comprise, for example, a foam material, such as expanded polystyrene. The filler material 52 acts as a bearing mechanism and inhibits radial motion of the outer sleeve 34′ relative to the inner sleeve 32′, thus maintaining concentricity of the outer sleeve 34′ and inner sleeve 32′. Furthermore, in embodiments having an elastomeric coupling 50′, the filler material may inhibit seeping of the elastomeric material during injection or curing of the elastomeric material.

Variations on the above are, of course, possible. As an example, in alternative embodiments, the male spline may be provided on an outer sleeve with the female spline on the inner sleeve.

As may be seen, embodiments according to the present disclosure provide compact torsional damper devices that may dampen torsional vibrations in vehicle drivelines. Furthermore, embodiments according to the present disclosure may be built relatively inexpensively using simple manufacturing techniques.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A torsional damper comprising:
an inner sleeve configured to couple with a shaft arranged concentrically with an axis of rotation, the inner sleeve having a generally annular profile with a male spline extending from an inner sleeve periphery;
an outer sleeve disposed about the inner sleeve and arranged concentrically with the inner sleeve, the outer sleeve having a generally annular profile with a female spline recessed within an outer sleeve periphery, the inner and outer sleeves being arranged with the male spline disposed within the female spline;
a resilient coupler arranged between the male spline and the female spline; and
a ball disposed between the inner sleeve and the outer sleeve and configured to inhibit radial motion of the outer sleeve relative to the inner sleeve.

2. The torsional damper of claim 1, wherein the resilient coupler comprises elastomeric material.

3. The torsional damper of claim 1, wherein the inner sleeve further includes a flange extending from the inner sleeve periphery, the flange having an outer surface with a groove thereon, the ball being retained in the groove.

4. The torsional damper of claim 1, wherein the outer sleeve comprises metal.

5. The torsional damper of claim 4, wherein the metal comprises iron or steel.

6. The torsional damper of claim 1, further comprising a drive shaft extending from a first end to a second end with a central portion therebetween, wherein the inner sleeve is concentrically coupled with the shaft.

7. A damper for a shaft, comprising:
a first sleeve having a generally ring-shaped cross-section with a male spline extending from a perimeter;
a second sleeve having a generally ring-shaped cross-section with a female spline recessed within a perimeter, the first and second sleeves arranged concentrically with the male spline disposed within the female spline;
an elastomeric material arranged between the male and female splines; and
a filler material disposed between the first and second sleeves.

8. The damper of claim 7, wherein the second sleeve is arranged about the first sleeve.

9. The damper of claim 7, wherein the female spline has a first sidewall and the male spline has a second sidewall, the elastomeric material being arranged between the first sidewall and the second sidewall.

10. The damper of claim 7, wherein the filler material comprises polystyrene.

11. A torsional damper comprising:
a first annular sleeve having an outer periphery with a lug extending therefrom;
a second annular sleeve having an inner periphery with a cavity recessed therein, the second annular sleeve being arranged concentrically about the first annular sleeve with the lug disposed in the cavity;
a resilient coupler disposed between the lug and the cavity; and
a bearing disposed between the first and second sleeves to inhibit relative motion therebetween.

12. The torsional damper of claim 11, wherein the first sleeve includes a second lug, a third lug, and a fourth lug extending from the outer periphery, the lugs being spaced generally equally about the outer periphery.

13. The torsional damper of claim 12, wherein the second sleeve includes a second cavity, a third cavity, and a fourth cavity recessed in the inner periphery, the cavities being spaced generally equally about the inner periphery, the second lug being disposed in the second cavity, the third lug being disposed in the third cavity, and the fourth lug being disposed in the fourth cavity.

14. The torsional damper of claim 11, wherein the resilient coupler comprises elastomeric material.

15. The torsional damper of claim 14, wherein the lug includes a lug sidewall and the cavity includes a cavity sidewall, the elastomeric material being disposed between the lug sidewall and cavity sidewall.

16. The torsional damper of claim 11, wherein the first sleeve further includes a flange extending from the inner sleeve periphery, the flange having an outer surface with a groove thereon, the ball being retained in the groove.

17. The torsional damper of claim 11, wherein the second sleeve comprises metal.

18. The torsional damper of claim 11, further comprising a drive shaft extending from a first end to a second end with a central portion therebetween, wherein the first sleeve is concentrically coupled with the shaft.

19. The torsional damper of claim 11, wherein the bearing includes a ball or pin.
